(19) United States
(12) Patent Application Publication
(10) Pub. No.: US 2026/0234807 A1
(43) Pub. Date: Aug. 13, 2026

(54) Lubricating a Metal Surface of a Metal Part, Such as a Glass Mould, by Cold Spraying a Metal Powder

(71) Applicant: ETABLISSEMENTS CHPOLANSKY, MARCOUSSIS (FR)

(72) Inventors: Fazati BOURAHIMA, MASSY (FR); Timothée LAURIDANT, GIF-SUR-YVETTE (FR)

(21) Appl. No.: 19/474,897

(22) PCT Filed: Apr. 29, 2024
(86) PCT No.: PCT/EP2024/061797

§ 371 Date: Oct. 13, 2025

(30) Foreign Application Priority Data
Apr. 28, 2023 (FR) FR2304300

(51) Int. Cl. C23C 24/04; C10M 103/04; C10M 103/06; C10N 50/08; C22C 9/06; C22C 19/05

(52) U.S. Cl. CPC C23C 24/04; C10M 103/04; C10M 103/06; C22C 9/06; C22C 19/058; C10M 2201/053; C10M 2201/0623; C10N 2050/08

(57) ABSTRACT

The present disclosure relates to a method for lubricating a metal surface (2) of a metal part that is configured to come into contact with a parison, such as a glass mould (1). This method comprises a step of cold spraying a metal powder (4) in the solid state onto the metal surface (2) so as to obtain a solid deposit (5). It also comprises a step (120) of machining the solid deposit (5) so as to obtain a lubricating coating (6). The present disclosure also relates to a metal powder, a surface treatment machine and a surface treatment facility for implementing such a method, and to a part obtained by means of such a method.

### TECHNICAL FIELD

The present application generally concerns metal castings in the field of glassmaking, especially molds made of cast iron, brass, bronze (and other alloys comprising copper and tin) or steel used to make glass objects such as bottles or in general any metal part likely to come into contact with the glass parison (or gob).

The present application more particularly concerns the lubrication of the metal surface of metal parts which comes into contact with the parison during the manufacture of glass objects. It finds a particular but non-limiting application in the lubrication of the molding surfaces of molds in order to improve the loading and unloading of the molds during the roughing phase.

### BACKGROUND

The manufacture of a glass object, especially hollow glass such as a bottle, is carried out in several steps.

During a first step, known as a roughing step, viscous glass is fused (at a temperature comprised between 700° C. and 1200° C.), poured in the form of a parison, then brought via a deflector and a distribution channel, into a mold, called a roughing mold. The viscous glass undergoes compression in the roughing mold and is then pierced in order to bring it into contact with the walls of the roughing mold and obtain a blank. The blank then has a temperature of up to 900° C., depending on the region and thickness of the blank.

Then, during a second step called blowing, the blank thus formed is transferred into a finishing mold to be blown to give it its final shape. During contact between the blank and the finishing mold, a sharp decrease in temperature occurs, as well as an elongation of the glass. The final product is obtained after this blowing step. It then has a temperature of around 600° C.

During the roughing step, several loading defects may appear (bone- or banana-shaped parison, off-center parison, etc.). In the case of a bottle type object, if these defects are minimal, only a few folds appear on the body of the bottle and/or on the shoulder. However, if the off-centering is too great, the parison cannot penetrate to the bottom of the roughing mold. The pressing against the walls of the roughing mold will therefore be degraded, which can lead to the formation of defects at the rings (neck of the bottle), and therefore to the bottle being scrapped.

It has therefore been proposed to lubricate the molding surface of the roughing molds, i.e., the surface which comes into contact with the parison, by regularly depositing a lubricant on this surface. The lubricant generally comprises a graphite grease to allow the parison to penetrate into the roughing mold and facilitate the removal of the blank from the mold.

However, this lubrication operation must be repeated very regularly in order to be effective, typically every twenty minutes, which reduces the productivity of the molding process. Moreover, it is generally carried out manually by the operators: The temperature in the vicinity of the roughing mold is very high, which creates a difficult working environment for the operators, the roughing molds themselves being at a temperature of around 500° C. In addition, clogging of the mold and the production machine can occur due to the presence of carbon residues from the use of graphite grease. Due to the successive opening and closing of the mold to allow lubrication, the temperature of the mold is also heterogeneous, which destabilizes the molding process. Finally, since the lubrication of the molds is not controlled (and is therefore not homogeneous over the entire molding surface of the roughing mold), localized wear by abrasion can appear and the lubricant can decompose under the effect of high temperatures.

It has also been proposed to replace lubrication with incomplete combustion of acetylenes. However, this combustion requires a constant presence of combustible spray gas on site which presents a high cost.

### DISCLOSURE

One object of the present application is to remedy the above-mentioned disadvantages.

To this end, according to a first aspect, the invention provides a method for lubricating a metal surface of a metal part configured to come into contact with a parison, for example a molding surface of a glassmaking mold, comprising the following steps:
cold spraying a metal powder in the solid state onto the metal surface so as to obtain a solid deposit, the metal powder comprising a mixture of a lubricating powder consisting of titanium dioxide and a matrix powder, the metal powder comprising between 3% and 10% by mass of lubricating powder, the balance being matrix powder; and
machining the solid deposit to obtain a lubricating coating.

Some preferred but non-limiting characteristics of the lubrication method according to the first aspect are the following, taken individually or in combination:
the matrix powder is essentially composed of, by mass relative to the total mass of the metal powder;
NiCr powder, the nickel content in the NiCr powder being comprised between 40 and 50% by mass and the chromium content being comprised between 50 and 60% by mass, relative to the total mass of the NiCr powder, it being understood that the sum of the components is equal to 100%; or
NiCr powder, the nickel content in the NiCr powder being comprised between 75 and 85% by mass and the chromium content being comprised between 25 and 15% by mass, relative to the total mass of the NiCr powder, it being understood that the sum of the components is equal to 100%; or
CuNiAlZn powder comprising: between 60% and 70%, preferably between 62% and 68%, of copper; between 7% and 17%, preferably between 10% and 15%, of nickel; between 5% and 15%, preferably between 8% and 12%, of aluminum; and between 5% and 15%, preferably between 8 and 12%, of zinc; it being understood that the sum of the components is equal to 100%;
the metal powder comprises 95% NiCr powder;
a particle size of the NiCr powder is comprised between 10 and 40 micrometers;
a particle size of the CuNiAlZn powder is greater than or equal to 15 microns and less than or equal to 45 microns
a particle size of the lubricating powder is comprised between 5 and 40 micrometers;
the metal powder is sprayed using a spray gas subjected to a pressure greater than thirty bars, for example between forty bars and seventy bars, for example approximately fifty bars;
the metal powder is sprayed using a spray gas heated to a temperature greater than or equal to 750° C., especially greater than or equal to 800° C., for example comprised between 900° C. and 1150° C.;
during the spraying step, a spraying distance, corresponding to a distance between a nozzle for spraying the metal powder and the metal surface, is comprised between 15 millimeters and 40 millimeters, preferably equal to approximately 20 millimeters;
during the spraying step, a travel speed of a nozzle for spraying the metal powder during spraying is comprised between 200 millimeters per second and 1000 millimeters per second, preferably between 200 and 450 millimeters per second;
the spraying step is carried out for a sufficient time to obtain a solid deposit having a thickness comprised between 0.3 millimeters and 3 millimeters, preferably between 0.5 millimeters and 1 millimeter; and/or
a delivery flow rate of the metal powder during the cold spraying step is comprised between 1 and 10 cm³/min, preferably between 2 and 3 cm³/min, for example around 2.5 cm³/min.

According to a second aspect, a metal part is proposed with a metal surface configured to come into contact with a parison, such as a glassmaking mold, the metal part comprising:
a metal surface; and
a lubricating coating covering all or part of the metal surface and comprising a metal alloy resulting from the cold spraying of a metal powder onto the metal surface in accordance with a lubrication method according to the first aspect.

Optionally, the metal surface comprises at least one of the following materials: graphite cast iron with lamellar, vermicular or spheroidal micrographic structure, an alloy based on copper and tin such as bronze, carbon steel, refractory steel or stainless steel, or brass.

### DESCRIPTION OF THE FIGURES

Other characteristics, objects and advantages will emerge from the following description, which is purely illustrative and non-limiting, and which must be read with reference to the attached drawings in which:

FIG. 1 schematically illustrates an example of an installation for lubricating a glassmaking mold according to one embodiment;

FIG. 2 is a flowchart illustrating the steps of a method for lubricating a surface of a metal part according to one embodiment;

FIG. 3 is a schematic sectional view of a metal part, here a glassmaking mold, comprising a lubricating coating according to one embodiment;

FIG. 4 is a schematic view showing a drop of parison on the free surface of a substrate such as a glassmaking mold;

FIG. 5 is a curve illustrating the viscosity of the glass constituting the drop of parison of FIG. 4 as a function of temperature.

In all the figures, similar elements bear identical references.

### DETAILED DESCRIPTION

In the following, the present disclosure will be described more particularly in the case of the lubrication of the molding surface 2 of a glassmaking mold 1. However, this is not limiting; the present disclosure applies to the lubrication of any metal surface of a metal part configured to come into contact with the parison.

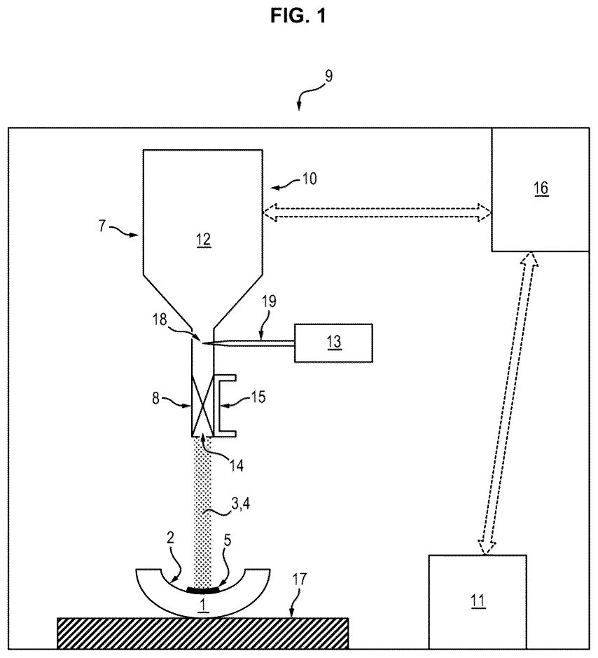

In reference to FIG. 1, the present application concerns the lubrication of all or part of the molding surface 2 of a glassmaking mold 1. The glassmaking mold 1 may especially comprise a roughing mold 1 configured to receive a drop of glass (parison) and form a blank. The molding surface 2 corresponds to the surface of the mold 1 likely to come into contact with the parison during the molding process. The molding surface 2 may especially comprise at least one of the following materials: graphite cast iron with a lamellar, vermicular or spheroidal micrographic structure, bronze (and other alloys comprising copper and tin), carbon steel, refractory steel or stainless steel type, or brass. Preferably, the glassmaking mold 1 is integrally formed from the same constituent material as the molding surface 2.

In order to lubricate the molding surface 2 of a glassmaking mold 1, it is proposed to spray a metal powder 4 cold and at a very high speed, by a spray gas 3 under high pressure transporting it onto all or part of the molding surface 2.

Cold spray at high pressure makes it possible to obtain a deposit density very close to the theoretical density of the solid metal material constituting the powder without heating the molding surface 2 during deposition, which avoids modifying the metallurgical quality of the molding surface 2 and of the solid deposit 5. In addition, it makes it possible to obtain high deposition thicknesses (up to several millimeters) with low roughness and a material efficiency of more than 90%, as well as a high interparticle cohesion. Moreover, the implementation of this cold spray does not require a prior step of preparing the molding surface 2 or of masking the mold 1 to be treated.

### Lubrication Installation 9

An installation 9 intended for this lubrication of all or part of the molding surface 2 of a glassmaking mold 1 is shown in FIG. 1. This installation 9 comprises a lubrication machine 10 and a machining station 11.

The lubrication machine 10 is configured to cold spray the metal powder 4, in solid form, onto the molding surface 2 of the mold 1. To this end, it comprises a spray nozzle 7, preferably made of ceramic, comprising:
a system for heating and pressurizing a spray gas 3, typically nitrogen or helium, in a pressurization chamber 12;
a powder dispenser 13 to supply the metal powder 4;
an injection system 18 to inject the metal powder 4 into the spray gas 3 downstream of the pressurization chamber 12 so that it is not heated by the lubrication machine 10 and therefore remains in the solid state;
a transport system 19 for transporting the metal powder 4 from the powder dispenser 13 to the injection system 18 by means of a carrier gas (typically identical to the spray gas 3);
a converging-diverging nozzle 8 placed downstream of the injection system 18 and configured to accelerate the spray gas 3 when it transports the metal powder 4, the diverging part of the nozzle 8 forming a deposition tube 14; and
a cooling system 15 which may comprise a conduit surrounding the deposition tube 14 in order to cool the spray gas 3, which transports the metal powder 4, by conduction by circulating a cooling fluid around the deposition tube 14; the cooling fluid may especially comprise distilled water at a temperature lower than the temperature of the spray gas 3, typically at a temperature comprised between 8 and 20° C.

The lubricating machine 10 further comprises a support 17 configured to fix the glassmaking mold 1 relative to the spray nozzle and actuators configured to move the spray nozzle 7 relative to the molding surface 2 in all three spatial directions. These actuators can move the spray nozzle 7, the support 17 on which the mold 1 is mounted or both the spray nozzle 7 and the support 17. The actuators are configured to move the nozzle relative to the molding surface 2 at a speed comprised between 200 millimeters per second (mm/s) and 1000 millimeters per second (mm/s). Preferably, in order to limit premature wear of the installation, and especially of the injection head, the sweeping speed is between 200 and 450 mm/s (to within 5%). The actuators are also configured to shift the impact zone by a distance comprised between 0.5 mm and 2.5 mm (no sweep between two adjacent beads), for example around one or two mm (to within 10%).

The heating system is configured to heat the spray gas 3 to a temperature greater than or equal to 750° C., especially greater than or equal to 800° C., for example comprised between 900° C. and 1150° C. The spray gas 3 is also pressurized in the pressurization chamber to a pressure greater than or equal to thirty-five bars, preferably between forty bars and seventy bars, for example around fifty bars.

The spray nozzle 7 can be controlled by a remote control station 16 placed close to the lubrication machine 10 or at a distance.

The machining station 11 comprises a support configured to receive the mold 1 coated with the solid deposit 5 and a machining tool, such as a milling machine, configured to machine the solid deposit 5 and obtain the lubricating coating 6. The machining tool can be manipulated by an operator or mounted on the installation 8 and controlled by a remote control station, for example the same control station 16 of the spray nozzle 7.

### Lubrication Method 100

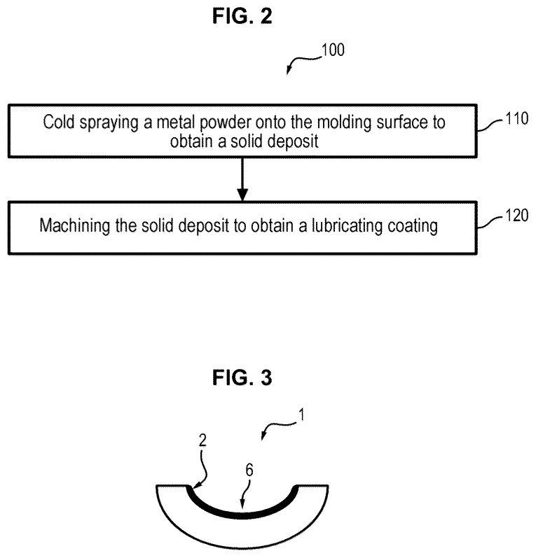

A method 100 for lubricating the molding surface 2, implemented by the lubrication installation 9, is shown in FIG. 2. It comprises the following steps:
cold spraying 110 a metal powder 4 in the solid state onto the molding surface 2 of the glassmaking mold 1 so as to obtain a solid deposit 5; and
machining 120 the solid deposit 5 to obtain a lubricating coating 6 (FIG. 3).

The method 100 can be applied to the entire molding surface 2 of the mold 1 or to only a portion of this surface 2.

During the spraying step 110, a spray gas 3 at high temperature (typically nitrogen or helium) and under high pressure is used to propel the metal powder 4 at a supersonic speed (greater than 300 m/s) onto the molding surface 2 in order to create a solid deposit 5 intended to form the lubricating coating 6 by impact of the metal powder 4 on the molding surface 2, the impact force ensuring the quality of the deposit. In the present application, the deposit is called “solid” insofar as the particles of the metal powder 4 remain in the solid state throughout the step 110 of spraying and adhering to the molding surface 2, as opposed to methods during which the temperature of the metal powder 4 exceeds its melting point so that all or part of the powder 4 melts at some point during the method 100. When the metal powder 4 comes into contact with the molding surface 2 at high speed, it is mechanically attached to the molding surface 2 by plastic deformation with strong adhesion, which makes it possible to avoid defects associated with high temperatures such as oxidation, residual stresses, phase transformations, etc. The solid deposit 5 is then integral with the molding surface 2, i.e., it can only be separated from the molding surface 2 by being completely or partially broken down.

The spraying step 110 is called cold insofar as the metal powder 4 is not heated before or during deposition, other than by its contact with the spray gas 3 or the molding surface 2.

During the spraying step 110, the spray gas 3 is heated and pressurized in order to guarantee that the metal powder 4 is sprayed at a spraying speed (speed of the metal powder 4 at the outlet of the nozzle 7) capable of allowing the plastic deformation of the metal powder 4 during its impact against the contact surface. It will be noted that the gas is heated and pressurized before injecting the solid powder into the gas and spraying it onto the molding surface 2 in order to guarantee that the metal powder 4 remains in the solid state. To this end, said spraying speed is greater than or equal to the critical speed of the metal powder 4. This critical speed corresponds to the speed at which the attachment (adhesion) of the solid deposit 5 is possible: When the impact speed is lower than the critical speed of the material, then the metal powder particles 4 do not deform plastically and can bounce and/or erode the molding surface 2. The critical speed depends on the nature of the material and the size of the particles of the metal powder 4. The critical speed is, for example, higher in the case of a metal powder 4 comprising a hard material, such as a titanium dioxide-based material (above 1250 m/s), than in the case of a metal powder 4 comprising a ductile material, such as a copper-based material (around 600 m/s). An equation E1 for determining the critical velocity of a material has been demonstrated by T. Schmidt, F. Gartner, H. Assadi and H. Kreye, “Development of a generalized parameter window for cold spray deposition”, Acta Mater. 54 (2006) 729-742; https://doi.org/10.1016/j.actamat.2005.10.005):

$${v}_{c r} = \sqrt{\frac{4 {F}_{1} {σ}_{u}}{ρ} ( 1 - \frac{{T}_{i} - {T}_{r}}{{T}_{m} - {T}_{r}} ) + {F}_{2} {c}_{p} ( {T}_{m} - {T}_{i} )} \qquad ( E1 )$$

where:
σᵤ is the breaking stress of the material;
ρ is the density of the material to be characterized;
Tₗ is the initial temperature of the material to be characterized;
Tₘ is the melting point of the material to be characterized;
cₚ is the specific heat;
Tᵣ is a reference temperature equal to 293 K; and
F₁ and F₂ are calibration coefficients used to recalibrate the calculated value to the measured speed values.

The pressure applied to the spray gas 3 is therefore chosen so as to exceed the critical speed of the metal powder 4 used for the solid deposit 5. A pressure greater than or equal to thirty-five bars, preferably greater than or equal to forty bars, for example equal to fifty bars, is suitable for most metal powders that can be used in the lubrication of a glassmaking mold 1.

Moreover, the temperature to which the spray gas 3 is heated is typically greater than or equal to 750° C., especially greater than or equal to 800° C., for example comprised between 900° C. and 1150° C. This heating temperature is advantageously at least 300° C. below the melting point of the constituent of the metal powder 4 with the lowest melting point and, for example, comprised between 30° and 700° C. below this melting point.

As applicable, the spray gas 3 can also be accelerated by the configuration of the spray nozzle 7 (modification of the gas passage section, for example in converging-diverging nozzle 8, etc.).

For a powder based on 50/50 nickel chromium described below, the critical speed is, for example, around 574 m/s.

As applicable, the spray gas 3 can be cooled downstream of the point of injection of the metal powder 4 into the gas in order to ensure that the metal powder 4 remains solid without reducing the spraying speed of the powder.

The spraying step 110 is carried out so as to obtain a solid deposit 5 whose thickness is sufficient to allow machining of the solid deposit 5 to obtain the lubricating coating 6. This thickness of the solid deposit 5 is typically comprised between 0.3 millimeters and 3 millimeters, preferably between 0.5 millimeters and 2.5 millimeters. The thickness of the coating 6 (after machining) can thus be comprised between 0.1 millimeters and 1.5 millimeters.

To this end, the molding surface 2 is moved relative to the lubrication machine 10 during the spraying step 110 in order to carry out a deposit on all or part of the molding surface 2. The spray nozzle 7 can be moved while the glassmaking mold 1 is stationary, or in a variant the glassmaking mold 1 can be moved while the spray nozzle 7 is stationary, or both the spray nozzle 7 and the glassmaking mold 1 are moved. The relative travel speed and the number of passes over a given surface determine the thickness of the deposit. For example, the relative travel speed of the spray nozzle 7 and of the molding surface 2 of the glassmaking mold 1 may be comprised between 200 millimeters per second (mm/s) and 1000 millimeters per second (mm/s), for example around 200 millimeters per second (mm/s) to 450 millimeters per second (mm/s) (to within 5%).

The delivery rate of the metal powder 4 by the dispenser 13 is comprised between 1 and 10 cm³/min, preferably between 2 and 3 cm³/min, for example around 2.5 cm³/min. The metal powder 4 thus supplied is transported entirely by the carrier gas to the injection system 18, so that this delivery flow rate also constitutes a flow rate of injection of the metal powder 4 into the spray gas 3 by the injection system 18. To this end, the carrier gas flow rate is typically comprised between 2.0 and 6.0 cubic meters per hour (m³/h), for example around 4.5 cubic meters per hour (m³/h) or 4.0 m³/h.

The size (width of the bead) of the solid deposit 5 is preferably comprised between 0.5 millimeters and two millimeters, for example around one millimeter (to within 10%). This size depends on the distance between the outlet of the spray nozzle 7 of the lubrication machine 10 and the molding surface 2 and on the outlet diameter of the spray nozzle 7. In order to obtain the abovementioned solid deposit size, said distance is typically comprised between fifteen millimeters and sixty millimeters, for example around twenty millimeters (to within 10%), for an outlet diameter of the spray nozzle 7 comprised between two and ten millimeters, for example around six millimeters.

The sweeping pitch (distance between the centers of two adjacent solid deposition beads 5) is comprised between 0.5 millimeters and two millimeters, for example around one millimeter (to within 10%). It is preferably substantially equal to the size of the solid deposit 5.

After machining, the porosity of the coating 6 may be comprised between 0.2% and 15%, preferably between 0.2% and 5.0%, given that the lower the porosity of the coating 6, the closer the behavior (in terms of sliding of the parison) of the lubricating coating 6 is to the behavior of a graphite grease. This porosity is a function of the spray parameters used in step 110. It is evaluated as follows:
a color image of the coating 6 is obtained with a Leica DMi8 C optical microscope using a 5× magnification and the automatic exposure parameters of the microscope;
this image is then binarized using ImageJ software (version 1.53±51), this binarization comprising the following steps:
   converting the image to 8-bit grayscale using the software ad hoc function, then
   converting to black and white using the automatic thresholding function (Yen method) of the software (thresholding function defining the gray intensity establishing the threshold between the pixels converted to white and those converted to black);
finally, the surface fraction of black pixels with respect to the rest of the image is calculated (equation E2), this surface fraction being assimilated to the degree of porosity:

$$\% porosity = \frac{{n}_{black pixels}}{{n}_{p i x e l s}} \qquad ( E2 )$$

### Metal Powder 4

The metal powder 4 preferably comprises 75% by mass or more of spherical particles, relative to the total mass of the powder.

The laser particle size distribution is measured according to ISO 13320:2019.

The diameter of the particles of the powder is advantageously comprised between 10 and 50 μm, especially between 12 and 45 μm, and preferably has a D50 value comprised between 20 and 30 μm.

The melting point of the powder compounds is typically higher than the temperature of the parison—which can reach 1100° C.—in order to avoid thermal degradation of the lubricating coating 6 during molding. Preferably, the melting point of the powder component having the lowest melting point is 300° C. higher than the parison temperature.

The “packing density” is evaluated according to NF EN ISO 3923 (2018) relating to “Metallic powders—Determination of apparent density after packing”. Typically, a test specimen with a volume of 25 cm³ and a KERN SEAL balance with a maximum capacity of 6000 g and a resolution of 0.1 g are used. Packing is stopped after 3000 strokes.

The “true density” is evaluated according to NF EN ISO 8130-2 (2011) “Coating powders—determination of density by gas comparison pycnometer (reference method)”. A helium pycnometer (Quantachrome UPYC 1200 e) with a 10 cm³ cell is used. The mass of the powder is measured with a balance, for example METTLER TOLEDO AB104 with a maximum capacity of 110 g and a resolution of 0.1 mg.

The packing density of the metal powder is typically comprised between 3 and 7 g/cm³

The true density is typically between 6 and 10 g/cm³, preferably with a small standard deviation, for example 0.001. Metal powders having such a true density make it possible to obtain a denser solid deposit 5.

Within the meaning of the present disclosure, a powder is “essentially composed” of a compound A when the powder comprises at least 98% by mass, preferably at least 99% by mass, of compound A, relative to the total mass of the powder.

The metal powder 4 comprises a first powder called a “matrix” powder to allow it to adhere to the molding surface 2. The first matrix powder imparts improved thermo-mechanical and/or heat diffusion properties to the coated mold.

The metal powder 4 also comprises, in addition to the matrix powder, a lubricating powder to facilitate penetration of the parison into the glassmaking mold 1 and to facilitate removal of the blank from the mold.

The metal powder 4 has a lubricating powder content of 3% to 10% by mass, typically 5% by mass, relative to the total mass of the metal powder 4.

The metal powder 4 is advantageously obtained by simply mixing the matrix powder and the lubricating powder. The person skilled in the art will know how to determine the duration, type and intensity of agitation necessary to obtain a homogeneous lubricating metal powder.

### Lubricating Powder

The lubricating powder may comprise or be composed of a metal oxide in powder form. Preferably, the lubricating powder comprises or is essentially composed of titanium oxide (denoted TiO₂).

The lubricating powder advantageously comprises at least 95% by mass, very advantageously at least 98% by mass of spherical particles, relative to the total weight of the lubricating powder.

The packing density of the lubricating powder is typically comprised between 0.8 and 1.8 g/cm³, especially between 1.0 and 1.5 g/cm³. The true density of the lubricating powder is typically comprised between 3.5 and 4.5 g/cm³, especially between 3.8 and 4.2 g/cm³.

The particle size of the lubricating powder is advantageously comprised between 5 and 40 μm. The D50 value of the lubricating powder is typically comprised between 15 and 20 μm.

### Matrix Powder Comprising an NiCr Alloy

According to a first embodiment, the matrix powder is essentially composed of an alloy of nickel and chromium (called nickel-chromium alloy and denoted NiCr). By essentially composed of, it will be understood here that at least 98% by mass of the NiCr powder is composed of the alloy of nickel and chromium, the remainder possibly comprising at most 2% by mass of another component. Preferably, the matrix powder comprises at least 99% by mass of NiCr. The other component may, for example, comprise at least one of the following elements: carbon, silicon, manganese, oxygen and nitrogen. A coating comprising NiCr confers thermomechanical protection to the mold. In particular, a coating comprising NiCr gives the mold better abrasion resistance, which is particularly useful in the case of molds for borosilicate glasses.

The nickel content in the NiCr alloy is advantageously comprised between 40% and 85% by mass, preferably between 45 and 80% by mass, relative to the total mass of the NiCr alloy, the balance essentially composed of chromium.

For example, the nickel content in the NiCr alloy is comprised between 40 and 50% by mass, while the chromium content is comprised between 50% and 60% by mass, relative to the total mass of the NiCr alloy (i.e., the balance necessary to reach essentially 100% of the mass of NiCr alloy), for example approximately 80% by mass of nickel and approximately 20% by mass of chromium (to within 1%) relative to the mass of NiCr alloy. In another embodiment, the nickel content in the NiCr alloy can be comprised between 75 and 85% by mass, the chromium content being comprised between 25% and 15% by mass, relative to the total mass of the NiCr alloy (i.e., the balance necessary to reach essentially 100% of the mass of NiCr alloy), for example approximately 80% by mass of nickel and approximately 20% by mass of chromium (to within 1%) relative to the mass of NiCr alloy.

The particle size of the NiCr matrix powder is advantageously comprised between 10 and 40 μm. The D50 value of the NiCr matrix powder is typically comprised between 20 and 30 μm.

The packing density of the NiCr matrix powder is typically comprised between 4 and 5 g/cm³, especially between 4.3 and 4.8 g/cm³. The true density of the NiCr matrix powder is typically comprised between 7.5 and 8.5 g/cm³, especially between 7.6 and 8.0 g/cm³.

According to an example of implementation of this first embodiment, the metal powder 4 comprises or is essentially composed of:
90 to 97% by mass, for example 95% by mass, of NiCr; and
3 to 10% by mass, especially 5% by mass, of titanium dioxide.

According to this example, the metal powder 4 can be obtained by mixing the NiCr powder with the titanium dioxide powder for 15 to 24 hours to obtain a homogeneous powder, for example for 17.5 h, then the mixture is placed in a hermetic chamber until use. In order to improve the homogeneity of the deposit, the mixture can be placed under an inert atmosphere in the hermetic chamber.

### Matrix Powder Comprising a Cupronickel Alloy

According to a second embodiment, the matrix powder comprises or is essentially composed of an alloy of copper, nickel, aluminum and zinc, which, for the sake of simplification, will hereinafter be called “cupronickel” or CuNiAlZn. A coating comprising a so-called cupronickel alloy gives the mold better heat diffusion properties, which makes it possible to cool the glass more homogeneously upon contact with the coated mold. Such a coating is particularly advantageous in the case of molds for soda-lime glasses.

According to this second embodiment, the matrix powder is essentially composed of a powder of an alloy comprising, by mass relative to the total mass of the alloy:
between 60 and 70%, preferably between 62 and 68% of copper;
between 7 and 17%, preferably between 10 and 15% of nickel;
between 5 and 15%, preferably between 8 and 12% of aluminum;
between 5 and 15%, preferably between 8 and 12% of zinc; and
any balance preferably being essentially composed of chromium, manganese and/or iron;
it being understood that the sum of the components is equal to 100%.

By essentially composed of, it will be understood here that the matrix powder comprises at least 97%, preferably at least 99%, of copper, nickel, aluminum and zinc. Typically, the other component represents at most 3% by mass, preferably at most 1%, relative to the total mass of the alloy. Preferably, the other component may comprise, by mass relative to the total mass of the alloy:
at most 1% chromium;
at most 1% manganese; and/or
at most 1% iron.

By way of non-limiting example, the cupronickel matrix powder may comprise (relative to the total mass of the matrix powder):
68.1% by mass (±0.4%) of copper;
15.4% by mass (±0.1%) of nickel;
9.02% by mass (±0.06%) of aluminum;
7.5% by mass (±0.1%) of zinc; and
640 ppm (m) of oxygen
   it being understood that the sum of the components is equal to 100%.

The packing density of the cupronickel matrix powder is typically comprised between 1 and 6 g/cm³, especially between 4.5 and 5.5 g/cm³. The true density of the cupronickel matrix powder is typically comprised between 4 and 9 g/cm³, especially between 7.5 and 9.0 g/cm³.

The particle size of the cupronickel matrix powder is advantageously comprised between 15 and 45 μm. The D50 value of the cupronickel matrix powder is typically comprised between 20 and 30 μm.

According to an example of implementation of this second embodiment, the metal powder 4 is essentially composed of:
90 to 97% by mass, for example 95% by mass, of cupronickel; and
3 to 10% by mass, especially 5% by mass, of titanium dioxide, it being understood that the sum of the components is equal to 100%.

According to this example, the metal powder 4 can be obtained by mixing the cupronickel powder with the titanium dioxide powder for 15 to 24 hours to obtain a homogeneous powder, for example for 17.5 h, then the mixture is placed in a hermetic chamber until use. In order to improve the homogeneity of the deposit, the mixture can be placed under an inert atmosphere in the hermetic chamber.

### Examples of the Lubrication of a Glassware Mold 1

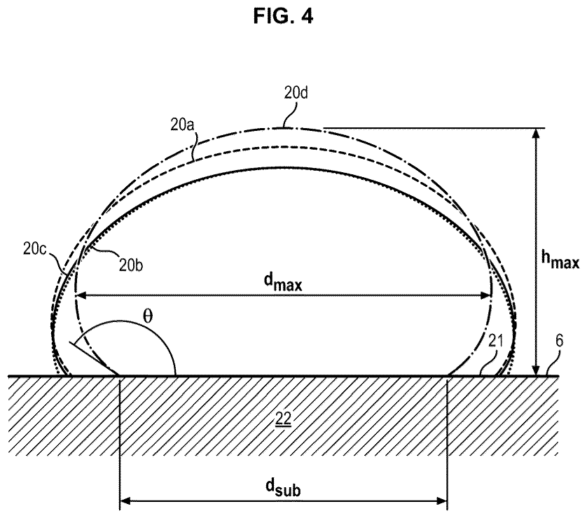

Examples of the lubrication of a glassmaking mold 1 will now be described with reference to FIG. 4.

### Example 1

### I—Materials and Methods

### Preparation of the Metal Powder 4

The metal powder 4 is obtained by mixing a matrix powder of NiCr with a lubricating powder of TiO₂, in the following proportions:
95% by mass of NiCr powder comprising 50% by mass of nickel and 50% by mass of chromium (i.e., in the total powder, 47.5% by mass of nickel and 47.5% by mass of chromium); and
5% by mass of titanium dioxide powder.

These powders are mixed for 17.5 hours to obtain a homogeneous metal powder 4, which is placed in a hermetic chamber until use.

The NiCr powder used is composed of an alloy comprising approximately 50% by mass of nickel and approximately 50% by mass of chromium. It is marketed by SANDVIK OSPREY.

The melting point of the NiCr compound is 1345° C.

The NiCr powder comprises at least 75% by mass, advantageously at least 80% by mass of spherical particles, relative to the total weight of the NiCr powder.

The mean value of the packing density after three measurements is 4.7 g/cm³.

The powder test sample for true density measurement was 30.8561 g. The mean true density value after five measurements was 7.71 g/cm³ with a standard deviation of 0.001.

Three measurements were carried out in order to determine the parameters D10, D50 and D90 (laser particle size analysis). The mean of these parameters is as follows:

$$D 10 = 14.7 μm ;$$

$$D 50 = 26.1 μm ; and$$

$$D 90 = 44. μm .$$

The TiO₂ powder used is marketed by Saint Gobain under the name “TiO₂ anastase nanostructured powder”.

The TiO₂ powder comprises at least 95% by mass, advantageously at least 98% by mass of spherical particles, relative to the total weight of the TiO₂ powder. The surface appearance of the particles is very smooth. At least 80% by weight of the particles have internal porosities, relative to the total weight of the TiO₂ powder.

The mean value of the packing density after three measurements is 1.2 g/cm³.

True density was measured under the same conditions as for NiCr, with a powder test sample of 7.3359 g. The mean true density value after five measurements was 4.16 g/cm³ with a standard deviation of 0.002.

Laser particle size analysis was carried out under the same conditions as for the NiCr compound: The mean of these parameters is as follows:

$$D 10 = 8.8 μm ;$$

$$D 50 = 17.8 μm ; and$$

$$D 90 = 33.9 μm .$$

### Preparation of Plates Representative of the Molding Surface of a Glassmaking Mold

Four flat plates 22 are prepared. Each plate 22 has a free surface 21 representative of the molding surface 2 of a glassmaking mold 1 and intended to receive a drop of glass.

The four plates 22 are made of graphite cast iron with a lamellar micrographic structure of the same composition.

A first of these plates 22 is untreated, i.e., neither the lubricating coating 6 nor a conventional lubricant such as graphite grease is applied to its free surface 21.

A second of these plates 22 has its free surface 21 coated with a conventional lubricant comprising a graphite grease. This grease, KleenMold® brand, comprises:
the following solid particles: calcium (Ca), sulfur (S), carbon (C), oxygen (O) and calcium carbonate (CaCO₃), and
the following binders: sulfur (S), silicon (Si) and chlorine (Cl).

A third of the plates 22 has its free surface 21 covered with a first lubricating coating 6 obtained according to the lubrication method 100 of the present disclosure, with the following parameters:
Laval type ceramic spray nozzle 7 (converging-diverging) with an outlet diameter of 6 mm;
spray gas 3: nitrogen;
gas temperature and pressure in pressurizing chamber 12: 1000° C., 50 bars;
coolant: distilled water;
distance between the outlet of the spray nozzle 7 and the impact zone on the molding surface 2: 20 mm;
spray nozzle 3 travel speed: 800 mm/s;
metal powder 4: composed of nickel-chromium and titanium dioxide, as described above, at room temperature (20° C.);
delivery rate of metal powder 4 from dispenser 13: 11.872 cm³/min;
carrier gas flow rate: 4.5 m³/h;
thickness of solid deposit 5: 0.5 mm;
thickness of the lubricating coating after machining the solid deposit: 0.2 mm;
porosity of the coating (after machining the solid deposit 5): approximately 1.3%;
adhesion of the lubricating coating 6 (after machining of the solid deposit 5): between 35 MPa and 45 MPa.

A fourth of the plates 22 has its free surface 21 covered with a bonding undercoat, itself coated with a second lubricating coating 6 obtained according to the lubrication method 100 of the present disclosure.

The bonding undercoat is obtained by cold spraying a powder essentially composed of an NiCr alloy comprising approximately 80% by mass of nickel and approximately 20% by mass of chromium, with the following parameters:
Laval type ceramic spray nozzle (converging-diverging) with an outlet diameter of 6 mm;
spray gas: helium;
gas temperature and pressure in pressurizing chamber 12: 750° C., 42 bars;
coolant: distilled water;
distance between the outlet of the spray nozzle and the impact zone on the molding surface: 30 mm;
spray nozzle travel speed: 800 mm/s;
powder delivery rate: 8.904 cm³/min;
carrier gas flow rate: 3 m³/h;
thickness of the solid deposit: between 250 and 350 μm.

The solid deposit 5 intended to form the second lubricating coating 6 is obtained with the following parameters:
Laval type ceramic spray nozzle 7 (converging-diverging) with an outlet diameter of 6 mm;
spray gas 3: nitrogen;
gas temperature and pressure in pressurizing chamber 12: 1000° C., 50 bars;
coolant: distilled water;
distance between the outlet of the spray nozzle 7 and the impact zone on the molding surface 2: 20 mm;
spray nozzle 3 travel speed: 800 mm/s;
metal powder 4: composed of nickel-chromium and titanium dioxide, as described above, at room temperature (20° C.);
delivery rate of metal powder 4 from dispenser 13: 11.872 cm³/min;
carrier gas flow rate: 4.5 m³/h;
thickness of solid deposit 5: 1 mm.

The solid deposit 5 was then machined so as to obtain a thickness of the lubricating coating 6, comprising the bonding undercoat, equal to approximately 1 mm. The porosity of the second lubricating coating (excluding the bonding undercoat) was measured at approximately 7.6%.

### II—Implementation

The four plates 22 of Example 1 are tested. To this end, each plate 22 is placed on a support, the free surface 21 of this plate 22 being oriented horizontally on the support, and a drop of glass 20a, 20b, 20c, 20d is applied to the free surface 21 of the plate 22 while the plate 22 is heated:
a first glass drop 20a is applied to the free surface 21 of the first plate 22,
a second glass drop 20b is applied to the free surface 21 of the second plate 22,
a third glass drop 20c is applied to the free surface 21 of the third plate 22, and
a fourth glass drop 20d is applied to the free surface 21 of the fourth plate 22.

The temperature of each plate 22 is measured between 440° C. and 450° C. during the deposition of the glass drop 20a, 20b, 20c, 20d on the plate 22.

The glass composing the drops 20a, 20b, 20c, 20d is the same for the four plates 22. It has the following composition (contents are expressed as a percentage by mass):
B₂O₃: 0.66%
Na₂O: 18.9%
MgO: 3.14%
Al₂O₃: 1.87%
SiO₂: 69.7%
SO₃: 0.15%
K₂O: 0.06%
CaO: 5.24%
TiO₂: 0.025%
Cr₂O₃: <0.020%
Fe₂O₃: 0.072%
ZrO₂: 0.021%
BaO: <0.02%
PbO: 0.014%.

For all elements except boron, the content was determined by quantitative analysis of the glass by X-ray fluorescence spectrometry (XRF). To this end, a first glass sample was first obtained by grinding and producing molten beads which were dissolved in a stream of lithium tetraborate. The sample was then analyzed using a BRUKER S4 Pioneer sequential wavelength dispersion spectrometer.

For boron, the content was determined by plasma-excited atomic emission spectrometry. To this end, a second glass sample was obtained by placing in acid solution after alkaline melting and removing the troublesome cations. The sample was then analyzed using a Varian Vista MPX plasma-excited atomic emission spectrometer.

From the contents of elements thus obtained, the contents of oxides were deduced by calculation.

The glass composing the drops 20a, 20b, 20c, 20d also has the following physical parameters:
thermal expansion coefficient (between 20° C. and 300° C.): 9.9×10⁻⁶±0.1×10⁻⁶ K⁻¹;
glass transition temperature: 513±6° C.;
softening temperature (Littleton point): 676±4° C.;
working temperature: 967±3° C.;
density: 2.484±0.003 g/cm³

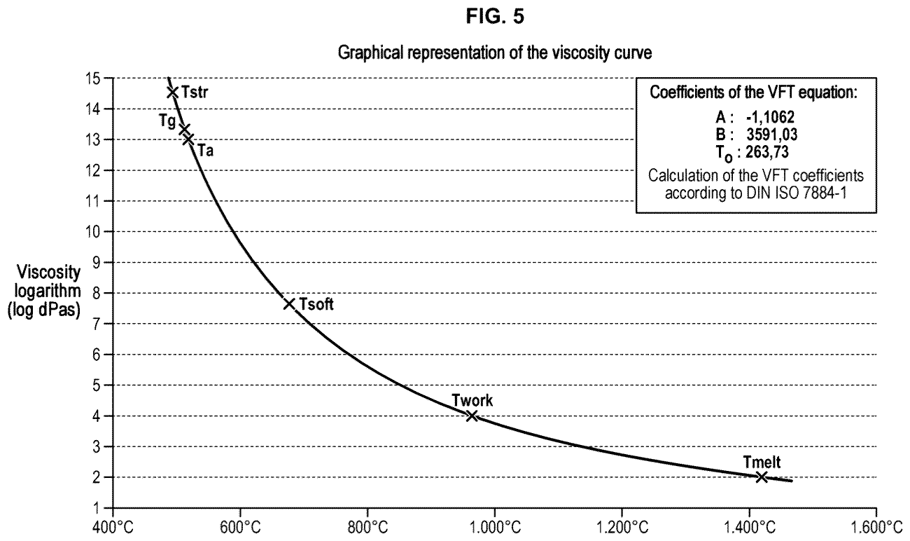

Finally, said glass has the viscosity curve illustrated in FIG. 5. These parameters and this curve are determined by application of ISO 7884.

The pouring temperature of the glass drops (parison) 20a, 20b, 20c, 20d is measured between 1050° C. and 1200° C. during their contact with the free surface 21 of the plate 22. Its flow speed is approximately 4 m/s. The diameter of each glass drop 20a, 20b, 20c is approximately 7 mm and its mass is 0.38±0.04 g.

### III—Results

The geometric properties of the drops 20a, 20b, 20c, 20d obtained are measured in order to determine the capacity of the lubricating coating 6 to improve sliding and/or promote the detachment of the drop 20 on the free surface 21 of the plate 22.

To this end, each glass drop 20a, 20b, 20c, 20d is filmed with the aid of a high-frequency acquisition camera in order to determine its geometric characteristics between 0 and 3 seconds after impact (i.e., as long as the drop is liquid, before it freezes) and to deduce therefrom the capacity of the lubricating coating to allow the drop 20a, 20b, 20c, 20d to slide on and/or detach from the free surface 21 of the plate 22.

The measurements are carried out by image processing and polynomial interpolation of the shape of the drop 20a, 20b, 20c, 20d on the four plates 22.

The mean measurements (obtained after measurements made on three hundred images and related to the initial diameter d₀ of the drop during the fall, before impact) are as follows:

| | | | Third drop 20c | Fourth drop 20d |
|---|---|---|---|---|
| | First drop | | (plate with | (plate with |
| | 20a (plate | Second drop | lubricating | lubricating |
| | without | 20b (plate | coating 6 (NiCr- | coating 6 (NiCr- |
| | lubricant or | coated with | TiO₂) having a | TiO₂) having a |
| | lubricating | conventional | mean porosity | mean porosity |
| | coating 6) | lubricant) | of 1.3%) | of 7.6%) |
| Drop diameter | 1.15 | 1.25 | 1.16 | 0.90 |
| at interface | | | | |
| with plate 22 | | | | |
| (d_{sub}/dₒ) | | | | |
| Maximum | 1.24 | 1.24 | 1.24 | 1.12 |
| drop diameter | | | | |
| (dₘₐₓ/d₀) | | | | |
| Maximum | 0.60 | 0.55 | 0.55 | 0.65 |
| drop height | | | | |
| (hₘₐₓ/d₀) | | | | |
| Drop wetting | 125° | 115° | 130° | 145° |
| angle (θ) | | | | |

The wetting angle of θ a drop 20a, 20b, 20c, 20d corresponds to the angle formed between the tangent to the free surface 21 of the plate 22 and the tangent to the surface of the drop 20a, 20b, 20c, 20d at the interface between the drop 20a, 20b, 20c, 20d and the free surface 21 of the plate 22.

Thus, all the geometric parameters measured show that the wetting of a glass drop on the free surface 21, when it is coated with the lubricating coating 6 of the plate 22, is reduced in comparison with the wetting of a substantially identical glass drop on the free surface of a plate 22 lubricated conventionally (graphite grease) or untreated.

The lubricating coating 6 therefore reduces the adhesion of the parison to the molding surface 2 and facilitates its detachment and penetration (sliding) into the glassmaking mold 1 and the demolding of the blank. Thus, it is possible to reduce the frequency of lubrication of the mold 1, or even to dispense with any new lubrication of the mold 1, without impairing the lubrication performance of the mold 1. This reduces lubrication costs and increases production throughput.

### Example 2

Five flat plates 22 are prepared. Each plate 22 has a free surface 21 representative of the molding surface 2 of a glassmaking mold 1 and intended to receive a drop of glass.

The five plates 22 are made of graphite cast iron with a lamellar micrographic structure of the same composition.

Each plate 22 has its free surface 21 covered with a lubricating coating 6 obtained according to the lubrication method 100 of the present disclosure, with the following parameters:

| | | Spray | Spray | | |
|---|---|---|---|---|---|
| | Spray | gas | gas | Sweeping | Sweeping |
| | distance | pressure | temperature | pitch | speed |
| Plate | (mm) | (bar) | (° C.) | (mm) | (mm · s⁻¹) |
| 1 | 20 | 50 | 1000 | 1 | 400 |
| 2 | 35 | 50 | 1000 | 2 | 200 |
| 3 | 20 | 50 | 1000 | 2 | 200 |
| 4 | 20 | 40 | 900 | 2 | 200 |
| 5 | 20 | 50 | 1100 | 1 | 400 |

For each of these plates, the following parameters were used:
Laval type ceramic spray nozzle 7 (converging-diverging) with an outlet diameter of 6 mm;
powder flow rate: 2.89 cm³/min;
spray gas 3: nitrogen;
spray gas flow rate: 4 m³/h;
coolant: distilled water;
metal powder 4: composed of nickel-chromium and titanium dioxide, as described in Example 1, at room temperature (20° C.); and
number of passes: 10

The efficiency of the cold spray parameters can be evaluated by measuring the thicknesses of the deposits obtained:

| | Deposit |
|---|---|
| | thickness |
| Plate | (mm) |
| 1 | 0.84 |
| 2 | 0.60 |
| 3 | 0.69 |
| 4 | 0.72 |
| 5 | 1.02 |

The plate 5 has an optimum thickness. The deposition efficiency of the plate 1 is also satisfactory.

The porosity of the coatings was evaluated by making a slice of the coating.

Comparison of plates 3 and 4 shows an equivalent efficiency and a similar porosity by increasing the pressure and temperature parameters (40 bar—900° C. to 50 bar—1000° C.). The plate 3 was produced with a sweeping pitch of 2 mm and a speed of 200 mm/s, whereas the coating of the plate 1 was produced with a pitch of 1 mm and a speed of 400 mm/s. As a result, the reduction of the pitch and the increase of the spray speed make it possible to increase the deposited thickness and to decrease the porosity (evaluated by image analysis at 1.0%±0.5 for the plate 1 versus 2.3%±0.3 for the plate 3).

Comparison of plates 1 and 5 demonstrates a gain in efficiency (ratio between the mass of the coating obtained and the mass of powder sprayed onto the plate) by increasing the temperature of the spray gas from 1000° C. (plate 1) to 1100° C. (plate 2). The deposition efficiency, abbreviated % DE of the plates 1 and 5 is 52% and 68% respectively.

The spray distance is optimized at 20 mm because there is a slight decrease in the thickness deposited on the plates 3 and 2 (20 mm and 35 mm).

The plate 5 leads to the thickest coating and, above all, to a very good compactness of the coating, which exhibits very few porosities. Quantification of the degree of porosity by image analysis evaluates the degree of porosity of the coating of plate 5 at 0.3%±0.05 and that of plate 3 at 2.3±0.3.

The following table gives the indices of porosity sizes (equivalent diameters in area) of the coatings of plates 3 and 5 calculated by image analysis. The minimum size of the porosities considered is 0.99 μm².

| | D(A)₁₀ | D(A)₅₀ | D(A)₉₀ |
|---|---|---|---|
| Plate | (μm) | (μm) | (μm) |
| 3 | 2.5 | 7.3 | 15.7 |
| 5 | 1.12 | 2.1 | 9.5 |

The median size (area equivalent) of the porosities is three times smaller in the coating of the plate 5 than in the coating of the plate 3. It should be noted that these porosity size values are satisfactory for an application to glassmaking molds.

The degree of bonding of the coating of the plate 3 is evaluated by image analysis at 83.7% and that of the plate 5 at 98.4%, demonstrating the excellent performance of the parameterization of the plate 5.

No cracks were found on any of the plates and cross sections analyzed.

The coating of the plate 5 is optimal from the point of view of thickness, porosity, efficiency and degree of bonding. The roughness of the coating 5 is equal to 7.0 μm (measured with a Mitutoty SJ210 roughness meter).

For NiCr powder, the optimized spray parameters are as follows:

| | | Spray | Spray | | | Powder | Carrier |
|---|---|---|---|---|---|---|---|
| | Spray | gas | gas | Sweeping | Sweeping | flow | gas flow |
| | distance | pressure | temperature | pitch | speed | rate | rate |
| Spray | 15-30 | 40-60 | 900-1150° | 0.5-2.5 | 200-450 | 2.89 cm³ · | 4 m³ · |
| parameters | mm | bar | C. | mm | mm · s⁻¹ | min⁻¹ | h⁻¹ |

| Particle size | | |
|---|---|---|
| of the powder | D(V)₁₀ | D(V)₉₀ |
| | −10 μm | +50 μm |

| Composition | | | | | | | |
|---|---|---|---|---|---|---|---|
| of the powder | Ni | Cr | C | Si | Mn | O | N |
| μm | 47-53 | 47-53 | <1 | <2 | <1 | <0.5 | <0.5 |

### Example 3

### Preparation of the Metal Powder 4

The metal powder 4 is obtained by mixing a matrix powder of NiCr with a lubricating powder of TiO₂, in the following proportions:
95% by mass of NiCr powder comprising 78.7% by mass of nickel (±0.6%) and 20.10% by mass of chromium (±0.05%) (i.e., in the total powder, 39.35% by mass of nickel and 10.1% by mass of chromium); and
5% by mass of titanium dioxide powder.

The NiCr powder used is Metco 43VF-NS powder marketed by SANDVIK OSPREY.

The exact composition of the powder is given below:

| % m | Ni | Cr | Si | Fe | O* |
|---|---|---|---|---|---|
| 80/20 | 78.7 ± | 20.10 ± | 0.992 ± | 0.244 ± | 4800 |
| NiCr Metco | 0.6 | 0.05 | 0.006 | 0.003 | ppm (m) |
| 43VF-NS | | | | | |

*The oxygen O content was quantified by instrumental gas analysis.

These powders are mixed for 17.5 hours to obtain a homogeneous metal powder 4, which is placed in a hermetic chamber until use.

The melting point of the NiCr compound is 1345° C.

The NiCr powder comprises irregularly shaped particles.

The mean value of the packing density after three measurements is 4.6 g/cm³.

The mean value of the true density after five measurements was 8.30 g/cm³.

Three measurements were carried out in order to determine the parameters D10, D50 and D90 (laser particle size analysis). The mean of these parameters is as follows:

$$D 10 = 11.7 μm ;$$

$$D 50 = 21.6 μm ; and$$

$$D 90 = 36.6 μm .$$

The TiO₂ powder is identical to that used in Example 1.

### Preparation of Plates Representative of the Molding Surface of a Glassmaking Mold

Seven flat plates 22 are prepared in an identical manner to Example 2, using 80/20 NiCr powder.

The seven plates 22 are made of graphite cast iron with a lamellar micrographic structure of the same composition.

Each plate 22 has its free surface 21 covered with a lubricating coating 6 obtained according to the lubrication method 100 of the present disclosure, with the following parameters:

| | | Spray | Spray | | |
|---|---|---|---|---|---|
| | Spray | gas | gas | Sweeping | Sweeping |
| | distance | pressure | temperature | pitch | speed |
| Plate | (mm) | (bar) | (° C.) | (mm) | (mm · s⁻¹) |
| 1 | 20 | 50 | 1000 | 1 | 400 |
| 2 | 20 | 50 | 1000 | 2 | 200 |
| 3 | 20 | 40 | 1000 | 2 | 200 |
| 4 | 20 | 40 | 900 | 2 | 200 |
| 5 | 35 | 50 | 1000 | 1 | 400 |
| 6 | 35 | 50 | 1000 | 2 | 200 |
| 7 | 20 | 40 | 800 | 1 | 400 |

For each of these plates, the following parameters were used:
Laval type ceramic spray nozzle 7 (converging-diverging) with an outlet diameter of 6 mm;
powder flow rate: 2.45 cm³/min;
spray gas 3: nitrogen;
spray gas flow rate: 4 m³/h;
coolant: distilled water;
metal powder 4: composed of nickel-chromium and titanium dioxide, as described in Example 3, at room temperature (20° C.); and
number of passes: 10

The efficiency of the cold spray parameters is evaluated by measuring the thicknesses of the deposits obtained:

| | Deposit |
|---|---|
| | thickness |
| Plate | (mm) |
| 1 | 1.03 |
| 2 | 0.84 |
| 3 | 0.98 |
| 4 | 0.98 |
| 5 | 1.13 |
| 6 | 0.88 |
| 7 | 1.12 |

The coating of the plates 1, 5 and 7 has an optimum thickness. The coatings were obtained with a pitch of 1 mm and a speed of 400 mm/s. This pair of spraying pitch and sweeping speed parameters are therefore relevant.

Analysis of the coatings of plates 1, 2, 3, 4 and 7 shows that it is advantageous to use lower pressure/temperature parameters for spraying 80/20 NiCr.

The efficiency obtained is satisfactory for all the plates (88% for plate 5 and 65% for plate 2, for example). The efficiency of plate 1 is calculated at 80%.

The porosity of the coatings was evaluated by making a slice of the coating. The coatings have a very good metallurgical quality, with a degree of porosity comprised between 1.5% and 4%.

The porosity of the coatings was evaluated by making a slice of the coating. The coatings of the plates 1 to 6 have a very good metallurgical quality, with a degree of porosity comprised between 1.5% and 3%.

The degree of bonding of the coatings is greater than 95% for each plate. The coating of the plate 7 has a lower degree of bonding and a higher degree of porosity which result in poorer metallurgical quality: This is due to the low temperature and pressure values of the spray gas (800° C. and 40 bar).

The following table gives the indices of porosity sizes (equivalent diameters in area) of the coatings of plates 1 and 7 calculated by image analysis. The minimum size of the porosities considered is 0.99 μm².

| | D(A)₁₀ | D(A)₅₀ | D(A)₉₀ |
|---|---|---|---|
| Plate | (μm) | (μm) | (μm) |
| 1 | 1.4 | 3.9 | 10.7 |
| 7 | 1.9 | 6.6 | 15.8 |

No cracks were found on any of the plates and cross sections analyzed. The coating of the plate 1 is optimal from the point of view of thickness, porosity, efficiency and degree of bonding. The roughness of the coating 1 is equal to 6.5 μm (measured with a Mitutoty SJ210 roughness meter).

### Example 4

### Preparation of the Metal Powder 4

The metal powder 4 is obtained by mixing a matrix powder of cupronickel with a lubricating powder of TiO₂, in the following proportions:
95% by mass of cupronickel powder; and
5% by mass of titanium dioxide powder.

The cupronickel powder used is marketed by NANOVAL. The exact composition of the powder is given below:

| % m | Cu | Ni | Al | Zn | O* |
|---|---|---|---|---|---|
| Cupronickel | 68.1 ± | 15.4 ± | 9.02 ± | 7.5 ± | 640 |
| | 0.4 | 0.1 | 0.06 | 0.1 | ppm (m) |

These powders are mixed for 17.5 hours to obtain a homogeneous metal powder 4, which is placed in a hermetic chamber until use.

The melting point of the powder is 1235° C.

The cupronickel powder comprises spherical particles, except for a few clusters which are very irregular. The particles do not have many satellites.

The mean value of the packing density after three measurements is 4.6 g/cm³.

The mean value of the true density after five measurements was 7.44 g/cm³.

Three measurements were carried out in order to determine the parameters D10, D50 and D90 (laser particle size analysis). The mean of these parameters is as follows:

$$D 10 = 14.8 μm ;$$

$$D 50 = 24.4 μm ; and$$

$$D 90 = 40. μm .$$

The TiO₂ powder is identical to that used in Example 1.

### Preparation of Plates Representative of the Molding Surface of a Glassmaking Mold

Eight flat plates 22 are prepared in an identical manner to Example 2, using 80/20 NiCr powder.

The eight plates 22 are made of graphite cast iron with a lamellar micrographic structure of the same composition.

Each plate 22 has its free surface 21 covered with a lubricating coating 6 obtained according to the lubrication method 100 of the present disclosure, with the following parameters:

| | | Spray | Spray | | |
|---|---|---|---|---|---|
| | Spray | gas | gas | Sweeping | Sweeping |
| | distance | pressure | temperature | pitch | speed |
| Plate | (mm) | (bar) | (° C.) | (mm) | (mm · s⁻¹) |
| 1 | 20 | 40 | 600 | 1 | 400 |
| 2 | | 50 | 600 | | |
| 3 | | 50 | 700 | | |
| 4 | | 40 | 800 | | |
| 5 | | 35 | 800 | | |
| 6 | | 35 | 900 | | |
| 7 | | 40 | 900 | | |
| 8 | | 40 | 1000 | | |

For each of these plates, the following parameters were used:
Laval type ceramic spray nozzle 7 (converging-diverging) with an outlet diameter of 6 mm;
powder flow rate: 2.5 cm³/min;
spray gas 3: nitrogen;
spray gas flow rate: 4 m³/h;
coolant: distilled water;
metal powder 4: composed of cupronickel and titanium dioxide, as described in Example 4, at room temperature (20° C.); and
number of passes: 10

The efficiency of the cold spray parameters is evaluated by measuring the thicknesses of the deposits obtained:

| | Deposit |
|---|---|
| | thickness |
| Plate | (mm) |
| 1 | 0.03 |
| 2 | 0.02 |
| 3 | 0.21 |
| 4 | 0.49 |
| 5 | 0.57 |
| 6 | 0.70 |
| 7 | 0.73 |
| 8 | 0.72 |

The coating of the plates 1 to 3 is too thin, which shows that the temperature of the spray gas must be at least equal to 800° C. The gain in efficiency is also quite substantial when the spraying temperature goes from 800° C. to 900° C. The efficiency is then stable for spray temperatures greater than or equal to 900° C.

The porosity of the coatings was evaluated by making a slice of the coating. The coatings have a very good metallurgical quality, with a degree of porosity comprised between 0.3% and 2%. The degree of porosity of the coating of the plate 7 is, for example, 0.3%, and that of the plates 5 and 8 is 1.4% and 1.0% respectively.

The porosity of the coatings was evaluated by making a slice of the coating. The coatings of the plates 1 to 6 have a very good metallurgical quality, with a degree of porosity comprised between 1.5% and 3%.

The following table gives the indices of porosity sizes (equivalent diameters in area) of the coatings of plates 1 and 7 calculated by image analysis. The minimum size of the porosities considered is 0.99 μm².

| | D(A)₁₀ | D(A)₅₀ | D(A)₉₀ |
|---|---|---|---|
| Plate | (μm) | (μm) | (μm) |
| 5 | 2.1 | 6.4 | 1.4 |
| 7 | 1.1 | 3.4 | 12.6 |
| 8 | 1.6 | 4.4 | 10.6 |

The degree of bonding of the plates 5 and 7 is 72% and 88% respectively, which is very good.

No cracks were found on any of the plates and cross sections analyzed.

The coating of the plate 7 is optimal from the point of view of thickness, porosity, efficiency and degree of bonding. The roughness of the coating 7 is equal to 7.6 μm (measured with a Mitutoty SJ210 roughness meter).

For cupronickel powder, the optimized spray parameters are as follows:

| | | Spray | Spray | | | Powder | Carrier |
|---|---|---|---|---|---|---|---|
| | Spray | gas | gas | Sweeping | Sweeping | flow | gas flow |
| | distance | pressure | temperature | pitch | speed | rate | rate |
| Spray | 15-40 | 40-50 | 800-1000° | 0.5-2.5 | 200-450 | 2-3.5 | 4 m³ · |
| parameters | mm | bar | C. | mm | mm · s⁻¹ | cm³ · min⁻¹ | h⁻¹ |

| Particle size | | |
|---|---|---|
| of the powder | D(V)₁₀ | D(V)₉₀ |
| | −10 μm | +50 μm |

| Composition | | | | | |
|---|---|---|---|---|---|
| of the powder | Cu | Ni | Al | Zn | O* |
| | 68.1 ± | 15.4 ± | 9.02 ± | 7.5 ± | 640 |
| | 0.4% m | 0.1% m | 0.06% m | 0.1% m | ppm (m) |

1. A lubrication method for a metal surface of a metal part configured to come into contact with a parison comprising the following steps:
cold spraying a metal powder in a solid state onto the metal surface so as to obtain a solid deposit, the metal powder consisting of a mixture of a lubricating powder and a matrix powder,
wherein the lubricating powder consists of titanium dioxide:
wherein the metal powder comprises between 3% and 10% by mass of lubricating powder, a balance being the matrix powder; and
machining the solid deposit to obtain a lubricating coating.

2. The lubrication method according to claim 1, wherein the matrix powder is essentially composed of, by mass relative to the total mass of the metal powder:
NiCr powder, the nickel content in the NiCr powder being comprised between 40 and 50% by mass and the chromium content being comprised between 50% and 60% by mass, relative to the total mass of the NiCr powder, wherein a sum of the nickel content and the chromium content is equal to 100%; or
NiCr powder, the nickel content in the NiCr powder being comprised between 75 and 85% by mass and the chromium content being comprised between 25% and 15% by mass, relative to the total mass of the NiCr powder, wherein a sum of the nickel content and the chromium content is equal to 100%; or
CuNiAlZn powder comprising:
between 60% and 70% of copper;
between 7% and 17% of nickel;
between 5% and 15% of aluminum; and
between 5% and 15% of zinc
wherein a sum of a copper, nickel, aluminum and zinc content is equal to 100%.

3. The lubrication method according to claim 2, wherein the metal powder comprises 95% of NiCr powder.

4. The lubrication method according to claim 2, wherein a particle size of the NiCr powder is comprised between 10 and 40 micrometers.

5. The lubrication method according to claim 2, wherein a particle size of the CuNiAlZn powder is greater than or equal to 15 microns and less than or equal to 45 microns.

6. The lubrication method according to claim 1, wherein a particle size of the lubricating powder is comprised between 5 and 40 micrometers.

7. The lubrication method according to claim 1, wherein the metal powder is sprayed using a spray gas at a pressure greater than thirty bars.

8. The lubrication method according to claim 1, wherein the metal powder is sprayed using a spray gas at a temperature greater than or equal to 750° C., especially greater than or equal to 800° C., for example comprised between 900° C. and 1150° C.

9. The lubricating method according to claim 1, wherein during the spraying step a spraying distance, corresponding to a distance between a nozzle for spraying the metal powder and the metal surface, is comprised between 15 millimeters and 40 millimeters.

10. The lubricating method according to claim 1, wherein during the spraying step, a travel speed of a nozzle for spraying the metal powder during spraying is comprised between 200 millimeters per second and 1000 millimeters per second.

11. The lubrication method according to claim 1, wherein the spraying step is carried out for a sufficient time to obtain a solid deposit having a thickness comprised between 0.3 millimeters and 3 millimeters.

12. The lubrication method according to claim 1, wherein a delivery flow rate of the metal powder during the cold spraying step is comprised between 1 and 10 cm³/min.

13. A metal part having a metal surface configured to come into contact with a parison, the metal part comprising:
a metal surface; and
a lubricating coating covering all or part of the metal surface and comprising a metal alloy resulting from the cold spraying of a metal powder onto the metal surface in accordance with a lubrication method according to claim 1, wherein the metal powder consists of a mixture of a lubricating powder and a matrix powder, and wherein the lubricating powder consists of titanium dioxide.

14. The metal part according to claim 13, wherein the metal surface comprises at least one of the following materials: graphite cast iron with lamellar, vermicular or spheroidal micrographic structure, an alloy based on copper and tin such as bronze, carbon steel, refractory steel or stainless steel, or brass.

15. The lubrication method according to claim 1, wherein the metal powder is sprayed using a spray gas at a pressure of fifty bars.

16. The lubrication method according to claim 1, wherein the metal powder is sprayed using a spray gas at a temperature comprised between 900° C. and 1150° C.

17. The lubricating method according to claim 1, wherein during the spraying step, a spraying distance, corresponding to a distance between a nozzle for spraying the metal powder and the metal surface, is comprised 20 millimeters.

18. The lubricating method according to claim 1, wherein during the spraying step, a travel speed of a nozzle for spraying the metal powder during spraying is comprised between 200 and 450 millimeters per second.

19. The lubrication method according to claim 1, wherein the spraying step is carried out for a sufficient time to obtain a solid deposit having a thickness comprised between 0.5 millimeters and 1 millimeter.

20. The metal part according to claim 13, wherein the matrix powder is essentially composed of, by mass relative to the total mass of the metal powder:
NiCr powder, the nickel content in the NiCr powder being comprised between 40 and 50% by mass and the chromium content being comprised between 50% and 60% by mass, relative to the total mass of the NiCr powder, wherein a sum of the nickel content and the chromium content is equal to 100%; or
NiCr powder, the nickel content in the NiCr powder being comprised between 75 and 85% by mass and the chromium content being comprised between 25% and 15% by mass, relative to the total mass of the NiCr powder, wherein a sum of the nickel content and the chromium content is equal to 100%; or
CuNiAlZn powder comprising:
between 60% and 70% of copper;
between 7% and 17% of nickel;
between 5% and 15% of aluminum; and
between 5% and 15% of zinc
wherein a sum of a copper, nickel, aluminum and zinc content is equal to 100%.
